(19) United States
(12) Patent Application Publication
(10) Pub. No.: US 2004/0207904 A1
(43) Pub. Date: Oct. 21, 2004

(54) Compact and stable broadband erbium amplified spontaneous emission (ASE) source

(76) Inventor: Jian Liu, Sunnyvale, CA (US)

Correspondence Address: Bo-In Lin, 13445 Mandoli Drive, Los Altos Hills, CA, 94022, US

(21) Appl. No.: 10/678,619

(22) Filed: Oct. 4, 2003

Related U.S. Application Data
(60) Provisional application No. 60/462,715, filed on Apr. 15, 2003.
(60) Provisional application No. 60/469,399, filed on May 12, 2003.

(51) Int. Cl. H01S 3/00

(52) U.S. Cl. 359/333

(57) ABSTRACT

A new configuration of ASE source for broadband application is disclosed that employs a single source, a pump splitter and a single EDF. A mirror is used with a first wavelength division-multiplexing device (WDM1) to feedback the ASE power from the port to WDM1 where the mirror can be simply implemented with a gold coating surface on the end of the fiber. With the use of a first and a second WDM, a single pump can be used to generate broadband output. A pump splitter is used with predefined splitting ratio to obtain predefined ASE emission from the ASE source. By adjusting the EDF type and length, pump power, and pump power splitting ratio, various ASE powers can be achieved.

This Formal Application claims a Priority Date of Apr. 15, 2003 and May 12, 2003 benefited from two Provisional Applications 60/462,715 and 60/469,399, filed by the same Applicant of this Application filed on Apr. 15, 2003 and May 12, 2003 respectively.

### FIELD OF THE INVENTION

The present invention relates generally to apparatuses and methods for providing amplified spontaneous emission (ASE) source for various applications, such as optical fiber sensor system, test and measurement of optical components, optical tomography, fiber gyros, fiber optical communications, and optical spectroscopy. More particularly, this invention relates to new configurations and methods for providing compact and stable erbium ASE source for optical fiber sensor systems and instrumentations.

### BACKGROUND OF THE INVENTION

Conventional technologies for configuring the ASE sources are still limited by several technical difficulties that such ASE emission source are assembled by using many optical components and thus becoming bulky and voluminous. The conventional ASE sources do not provide a wide and flat spectrum for the broadband application. Furthermore, The ASE sources assembled with conventional configuration would not have proper form factor suitable for modern fiber optical application due to their large sizes. These difficulties often limit the usefulness of the ASE sources. It is critical to make an ASE source with a broadband spectrum and with a small form factor for those applications.

Specifically, conventional ASE sources are typically implemented by incorporating filter and other components, such as Faraday rotator mirror to assemble into the ASE sources. These approaches are generally too complicated and difficult to fit into a small form factor. Furthermore, the conventional ASE sources do not provide specific methodologies to address the issues of how to obtain a broadband ASE source and to achieve a flat spectrum over the broadband spectrum. (References: D. M. Baney and W. V. Sorin, Variable spectral width optical noise source, U.S. Pat. No. 5,361,161, 1994. . . . Variable spectral width multiple path optical noise source, U.S. Pat. No. 5,272,560, 1993). Recently, R. P. Espindola, et al., proposed a two stages approach in achieving a flat 80 nm ASE source (reference: R. P. Espindola, G. Ales, J. Park, and T. A. Strasser, 80 nm spectrally flattened, high power erbium amplified spontaneous emission fiber source, Electronics Letters, 36(15), 1263-1265 (2000)). However, this approach involves in use of a complex gain-flattening filter, e.g., fiber Bragg grating, which is complicated in design and difficult to fabricate and requires a high power 1480 nm pump laser (over 100 mW) and very long length of high concentration Erbium doped fiber (EDF). These attempts although useful as references, would not provide practical and useful solutions to the difficulties as now encountered by the conventional technologies.

Therefore, a need still exists in the art of optical component design and manufacture to provide a new and improved ASE source to provide emission source with small form factor and flat spectrum over the full range wavelengths over the C and L bands to overcome the above mentioned technical difficulties encountered by the prior art ASE sources.

### SUMMARY OF THE PRESENT INVENTION

It is therefore an object of the present invention to provide an ASE source that uses less number of components and short length of EDF with simplified configuration and eliminating the requirement to use a Faraday rotator and filters such that compact broadband ASE source can be provided such that the difficulties and limitations of the conventional ASE sources can be resolved.

Specifically, it is an object of the present invention to provide a new configuration ASE source for broadband application that employs a single pump source, a pump splitter and a single EDF. A mirror is used with a first wavelength divisional multiplexing device (WDM1) to feedback the backward propagating C-band ASE power generated from the pumped EDF back to the EDF (becomes forward propagation to pump L-band ASE) through the WDM1 where the mirror can be simply implemented with a gold coating surface on the end of the fiber pigtail of the WDM1 or on the end surface of a piece of fiber and then spliced with WDM1. With the use of a first and a second WDM with a pump splitter and one piece of EDF, a single pump can be used to generate broadband output. A pump splitter is used with predefined splitting ratio to obtain predefined ASE emission from the ASE source By adjusting the EDF type and length, pump power, and pump power splitting ratio, various ASE powers can be achieved.

Briefly, in a preferred embodiment, the present invention discloses an ASE source that includes a reflective means attached to and reflecting a feedback light to the gain medium through a WDM, i.e., a wavelength demultiplexing-multiplexing means. In a preferred embodiment, the ASE source further includes a single piece of erbium-doped fiber (EDF) connected to the WDM means for projecting a light having a broadband range over eighty nanometers (nm). In a preferred embodiment, the ASE further includes an erbium-doped fiber (EDF) connected to the WDM means for projecting a light having a broadband range over eighty nanometers (nm). And, the reflective means comprising a reflective coating coated over an end face of the fiber pigtail. In a preferred embodiment, the ASE further includes an erbium-doped fiber (EDF) connected to the WDM means for projecting a light having a broadband range over eighty nanometers (nm). And, the ASE further includes a single laser pump projecting a laser of a single wavelength into the EDF. In a preferred embodiment, the ASE further includes a pump splitter for splitting the laser projecting from the single laser pump with a specific ratio into two braches of the EDF. In a preferred embodiment, the ASE further includes a pump power adjusting means for adjusting power of the laser pump to adjust an output power of the ASE. In a preferred embodiment, the ASE further includes a splitter adjusting means for adjusting the specific ratio into the two branches for adjusting an output power of the ASE.

In a preferred embodiment, this invention further discloses a method for providing an amplified spontaneous emission source (ASE) that includes steps of reflecting a feedback light to a wavelength demultiplexing-multiplexing (WDM) means. In another embodiment, the ASE further includes a step of connecting the WDM means to an erbium doped fiber (EDF) connected for projecting a light having a broadband range over eighty nanometers (nm). In another preferred embodiment, the method further includes a step of providing the reflective means by coating a reflective coating over an end face of a fiber sliced into a wavelength division multiplexing (WDM) device connected to the EDF.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a schematic functional block diagram for showing an broadband ASE source of this invention.

FIGS. 2A to 2C are diagram for showing the spectrum transform during an optical transmission of a C-band signal in an erbium doped fiber (EDF) over a different distances in the EDF.

FIG. 3 is a diagram for showing the experimental results of a broadband ASE output power versus wavelength with three different pump power and splitting ratio.

### DETAILED DESCRIPTION OF THE INVENTION

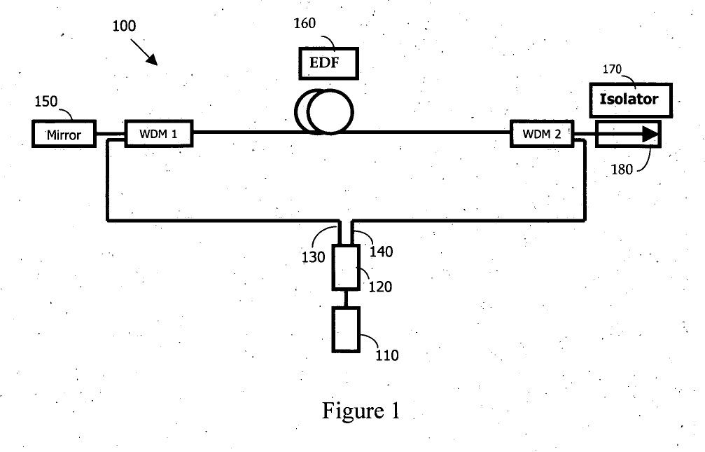

Fig. 1 shows a schematic diagram of a broad band ASE source 100 of this invention. The broadband source 100 uses one pump laser 110 either at 980 nm or 1480 nm to pump one Erbium doped fibers (EDFs). A pump splitter 120 is used to split the pump power into the two pumping ports 130 and 140 of the EDF at a given ratio of splitting. As will be described below, by changing the ratio and total pump power, different output power of ASE source is generated. The pump splitter 120 can be either filter type or fused fiber type. The split optical pump lights are transmitted into a left branch 150 and a right branch each branch having a wavelength division multiplexing (WDM), WDM1 and WDM2 respectively. A mirror 150 is disposed close to WDM 1. The mirror 150 is used to feedback the C band ASE into the Erbium doped filter (EDF) 160 in order to obtain L band ASE source. The pump power from the WDM 2 is transmitted into the EDF to perform both functions of generating C band ASE source and further pumping L band source. In this way, the pump power is efficiently used and converted into ASE power. An isolator 170 is used in the output port 180 to block any back reflection. The EDF 160 used in the invention can be any one commercially available, such as Lucent GP 980, MP 980, HP 980, HE 980, and high doping concentration fibers LSL, LRL, and R37103.

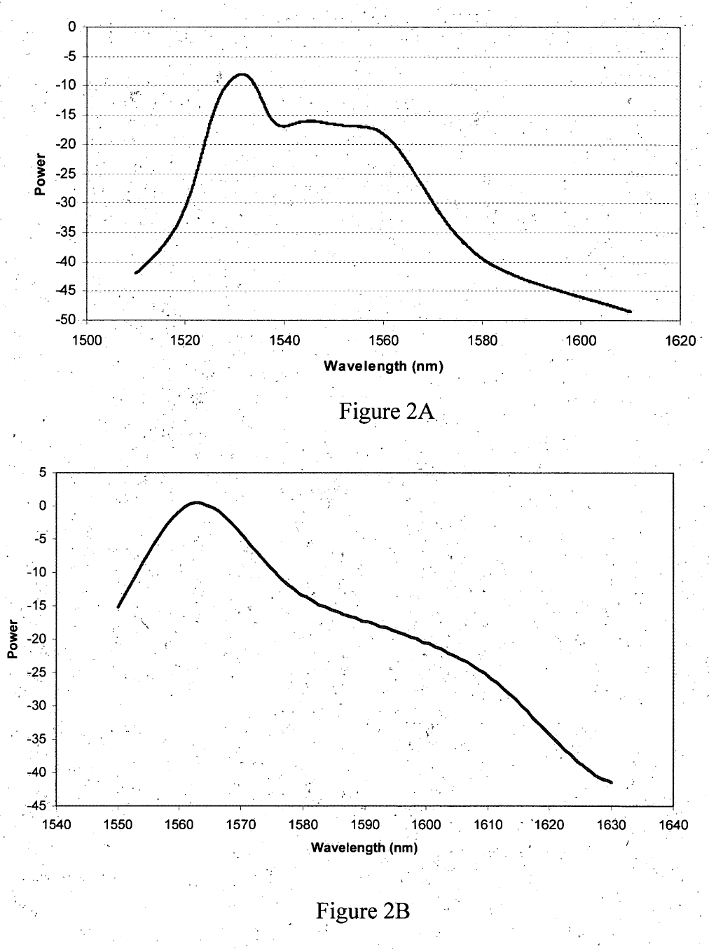

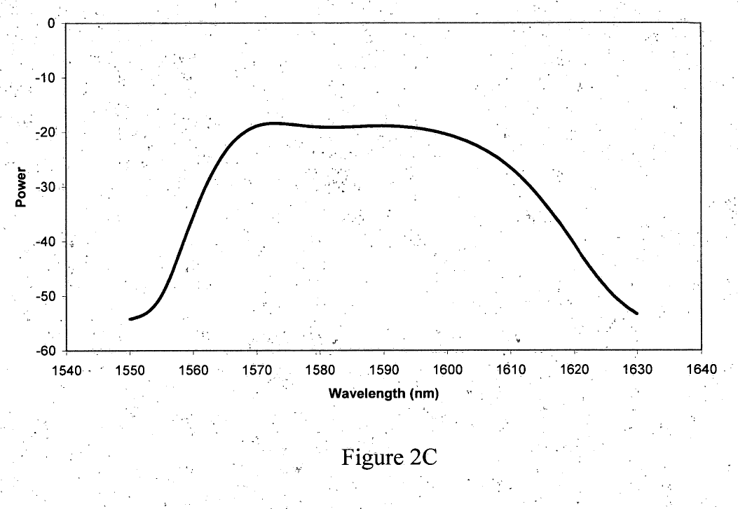

Referring to FIGS. 2A to 2C for a special feature of this invention when pumping light into the erbium doped fiber through wavelength division multiplexing (WDM) device and then combined with the reflected emission through the WDM device. In FIG. 2A, as the mirror 150 reflects the C band signal back to the EDF 160, the spectrum shows that the peak of the optical signals are around a wavelength of 1550 nm at a position of 10 m of the fiber. An Erbium doped fiber has a special energy activation and transformation characteristic that as the optical transmission passing along the fiber, the energy level of the erbium ions in the fiber will be re-pumped up to a higher level by the feedback C-band high frequency (shorter wavelength) energy. Then another optical emission of lower frequency (corresponding to longer wavelength) is released as the pumped erbium ions decay from this higher and unstable level to a lower more stable energy level. Because of this optical energy activation and transformation characteristic, the shape of the spectrum undergoes a change as that shown in FIGS. 2B and 2C. As shown in FIG. 2B, at a length of 30 meters, an energy transformation occurs. Then at a length of 50 meters, an optical energy at a longer wavelength occurs thus generates the wavelength transmission in the L band range. Taking advantage of this special optical transmission and “wavelength transformation” characteristic of erbium doped fiber 160, a single stage broad band ASE can be configured without requiring additional filter and other wavelength adjustment components as that disclosed in the prior art ASE configurations.

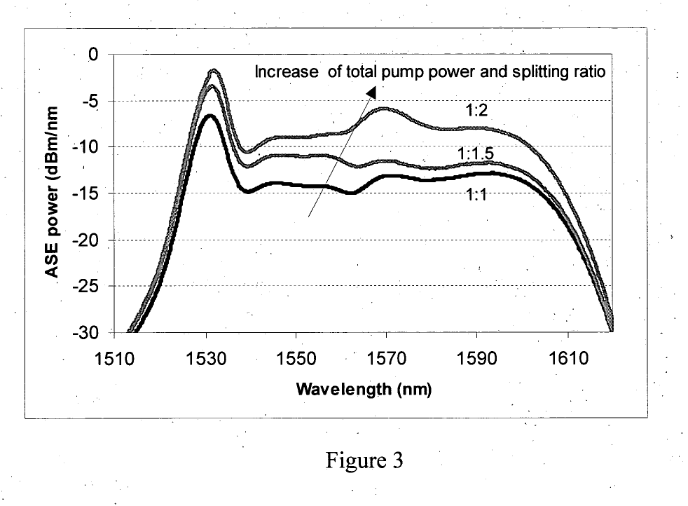

An example is given here in FIG. 3 for demonstration of the working principle of the invention. In the invention, selection of EDF, fiber length, pump power and splitting ratio are important to the broadband ASE source in terms of output power and bandwidth. A 50 meter of GP 980 EDF from Lucent is used as a gain medium. Various pump power (50 mW to 80 mW) and splitting ratio (1:1 to 1:2) can be used to obtain different output powers of broadband ASE source. It is clearly shown that by properly selecting the pump power and splitting ratio, over 80 nm broadband ASE spectra can be achieved. The excellent power stability was achieved as well (<±0.005 dB) due to a simple configuration and the least components required in an ASE source of this invention.

The embodiments as show above provide an ASE source that uses one piece of EDF to obtain broadband ASE source over 80 nm. In this ASE broadband source as shown, it uses a mirror to feed back the ASE power from the port of WDM 1. The mirror can be simply a gold coated on the end face of the fiber pigtail of the WDM or a piece of single fiber. In this improved configuration, only one pump is used in the broadband ASE source by utilizing a pump splitter (either filter type or fused fiber type) to split the pump at an appropriate ratio. By adjusting the EDF type and length, pump power, and pump power splitting ratio, various ASE powers can be achieved.

A broadband ASE source as disclosed by this invention uses the least number of components and the simplest design to obtain a broadband spectrum over 80 nm covering both C and L bands. This will significantly reduce the size and power consumption of the ASE source. Based on these technologies, a series of mini-broadband ASE source modules that covers C. L and C+L bands to satisfy the requirements of various applications with different power levels, e.g., from 5 dBm to 14 dBm. Built-in electronics are formed in a module that provides interface, e.g., RS232 and customer defined interfaces, to a computer for ease of automation and system integration. The ASE source module has a broadband range of greater than 80 nm with excellent power stability and flat and stable spectrum. The module is also formed with small form factor produced with low costs and operated with low power consumptions.

According to above descriptions and disclosures made in FIGS. 1 to 3, this invention discloses an amplified spontaneous source (ASE) 100. The ASE includes an optical pump 110 coupled to a pump splitter 120 for projecting a first and a second pump lights 130 and 140 to a first end and a second end respectively of an erbium doped fiber (EDF) 160 for generating a first amplified spontaneous emission (ASE) and a second ASE respectively. The ASE 100 further includes a reflecting means 150 for reflecting the first ASE via a first wavelength selection means WDM1 back to the EDF for transmitting and effecting a spectrum transform of the first ASE to generate a spectrum-transformed ASE in the EDF. The ASE further includes a second wavelength selection means WDM2 coupled to the pump splitter 120 for receiving the pump light into the EDF 160 for generating the second ASE to combine with the spectrum-transformed ASE for generating an output optical signal having a broader spectrum than the first ASE and second ASE. In a preferred embodiment, the spectrum-transformed ASE generated in the EDF comprising substantially a L-band signal and the second ASE generated in the EDF comprising substantially a C-band signal for generating an output optical signal having a C-band and L-band combined signal. In another preferred embodiment, the reflecting means 150 comprising a reflective coating onto a end-surface of an optical fiber spliced with the first wavelength selective means WDM1. In another preferred embodiment, the first wavelength selection means WDM1 and the second wavelength selection means WDM2 are respectively a first and a second wavelength division-multiplexing (WDM) devices. In another preferred embodiment, the pump splitter 120 is an adjustable pump splitter for adjusting a power ratio of projecting the first and the second pump lights. In a different embodiment, the pump splitter 120 is an fixed-ratio pump splitter for pumping a fixed power ratio of the first and the second pump lights. In yet another preferred embodiment, the reflecting means comprising a reflective coating onto an fiber end-surface of the first WDM, e.g., WDM1.

In essence, this invention discloses an amplified spontaneous source (ASE) that includes an optical pump 110 coupled to a pump splitter 120 for projecting a first and a second pump lights 130 and 140 into a gain medium 160. The ASE further has a reflecting means 150 for reflecting the first pump light into the optical gain medium 160 for transmitting and effecting a spectrum transform of the first pump light therein to generate a spectrum transformed ASE for generating an output optical signal having a spectrum including a spectrum-transformed wavelength range as that shown in FIGS. 2A to 2C. In a preferred embodiment, the ASE further includes a first wavelength division-multiplexing (WDM) means WDM1 for multiplexing an ASE reflected from the reflecting means 150 into the optical gain medium 160 and a second WDM means WDM2 connected to the gain medium 150 opposite the first WDM means WDM1 for multiplexing a second ASE generated from the second pump light generating a combined output optical signal having a broader spectrum than the first ASE generated from the first pump light in the gain medium and the second ASE. In a specific embodiment, the gain medium 160 is an erbium doped fiber (EDF). In a preferred embodiment, the erbium doped fiber (EDF) having a pre-designated length for effecting the spectrum transform of the first ASE reflected into the EDF (See FIGS. 2A to 2C). In another preferred embodiment, the reflective means comprising a reflective coating coated over an end face of the fiber. In another preferred embodiment, the first ASE generated from the first pump light in the gain medium having a peak wavelength near a C-band into the gain medium for effecting the spectrum transform for generating a substantially flat L-band ASE as that shown in FIGS. 2A to 2C. In another preferred embodiment, the second ASE generated in the gain medium is a C-band optical signal for combining with the substantially flat L-band signal to project an output optical signal having a broadband range over eighty nanometers (nm) as that shown in FIG. 3.

As shown in FIG. 1, this invention discloses an amplified spontaneous source (ASE) that includes an erbium doped fiber (EDF) 160 for transmitting an amplified spontaneous emission (ASE) signal therein. The ASE further includes a reflective means 150 for reflecting a reflected ASE having a peak wavelength near a C-band into the EDF for generating a substantially flat L-band optical signal. The ASE further includes a wavelength division-multiplexing (WDM) means WDM! for demultiplexing an ASE signal reflected from the reflective means 150 into the EDF 160. In a specific embodiment, the erbium doped fiber (EDF) 160 having a pre-designated length for effecting a generation of the substantially flat L-band ASE signal as that shown in FIGS. 2A to 2C. In a preferred embodiment, the reflective means 150 comprising a reflective coating coated over an end face of an optical fiber spliced into a wavelength selective means WDM1. In a preferred embodiment, the ASE further includes a means 110 for pumping a light generating a second C-band ASE signal for combining with the substantially flat L-band signal to project an output optical signal having a broadband range over eighty nanometers (nm) as that shown in FIG. 3.

Therefore, this invention discloses a method for generating a broadband signal that includes a step of projecting a first pump light 130 into an gain medium 160 for transmitting and reflecting an ASE signal generated by the pump light in the gain medium for generating a spectrum-transformed ASE signal as that shown in FIGS. 2A to 2C having a broadband ready-combination spectrum, e.g., spectrum as shown in FIG. 2C, over a range of wavelengths of the broadband signal. In a preferred embodiment, the method further includes a step of projecting a second pump light 140 into the gain medium 160 for generating a second ASE signal for combining with the spectrum-transformed ASE signal into the broadband optical signal as that shown in FIG. 3.

FIG. 1 shows an amplified spontaneous source (ASE) of this invention that includes a single segment of gain medium 160 for outputting a broadband optical signal therefrom as that shown in FIG. 3. FIG. 1 further shows an amplified spontaneous source (ASE) that includes a single pump source 110 connecting to a single pump splitter 120 to project two branched pump lights 130 and 140 into a single segment of gain medium 160 for outputting a broadband optical signal therefrom as that shown in FIG. 3. FIG. 1 further shows an amplified spontaneous source (ASE) that includes a single segment of gain medium 160 for outputting a broadband optical signal therefrom having a broadband range about 80 nanometers and a flat spectrum as that shown in FIG. 3.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An amplified spontaneous source (ASE) comprising:
an optical pump coupled to a pump splitter for projecting a first and a second pump lights to a first end and a second end respectively of an erbium doped fiber (EDF) for generating a first amplified spontaneous emission (ASE) and a second ASE respectively;
a reflecting means for reflecting said first ASE via a first wavelength selection means back to said EDF for transmitting and effecting a spectrum transform of said first ASE to generate a spectrum-transformed ASE in said EDF;
a second wavelength selection means coupled to said pump splitter for receiving said pump light into said EDF for generating said second ASE to combine with said spectrum-transformed ASE for generating an output optical signal having a broader spectrum than said first ASE and second ASE.

2. The ASE of claim 1 wherein:
said spectrum-transformed ASE generated in said EDF comprising substantially a L-band signal and said second ASE generated in said EDF comprising substantially a C-band signal for generating an output optical signal having a C-band and L-band combined signal.

3. The ASE of claim 1 wherein:
said reflecting means comprising a reflective coating onto a end-surface of an optical fiber spliced with said first wavelength selective means.

4. The ASE of claim 1 wherein:
said first wavelength selection means and said second wavelength selection means are respectively a first and a second wavelength division-multiplexing (WDM) devices.

6. The ASE of claim 1 wherein:
said pump splitter is an adjustable pump splitter for adjusting a power ratio of projecting said first and said second pump lights.

7. The ASE of claim 1 wherein:
said pump splitter is an fixed-ratio pump splitter for pumping a fixed power ratio of said first and said second pump lights.

8. The ASE of claim 4 wherein:
said reflecting means comprising a reflective coating onto an fiber end-surface of said first WDM.

9. An amplified spontaneous source.(ASE) comprising:
an optical pump coupled to a pump splitter for projecting a first and a second pump lights into a gain medium; and
a reflecting means for reflecting said first pump light into said optical gain medium for transmitting and effecting a spectrum transform of said first pump light therein to generate a spectrum transformed ASE for generating an output optical signal having a spectrum including a spectrum-transformed wavelength range.

10. The ASE of claim 9 further comprising:
a first wavelength division-multiplexing (WDM) means for multiplexing an ASE reflected from said reflecting means into said optical gain medium and a second WDM means connected to said gain medium opposite said first WDM means for multiplexing a second ASE generated from said second pump light generating a combined output optical signal having a broader spectrum than said first ASE generated from said first pump light in said gain medium and said second ASE.

11. The ASE of claim 9 further wherein:
said gain medium is an erbium doped fiber (EDF).

12. The ASE of claim 11 wherein:
said erbium doped fiber (EDF) having a pre-designated length for effecting said spectrum transform of said first ASE reflected into said EDF.

13. The ASE of claim 9 wherein:
said reflective means comprising a reflective coating coated over an end face of said fiber.

14. The ASE of claim 9 wherein:
said first ASE generated from said first pump light in said gain medium having a peak wavelength near a C-band into said gain medium for effecting said spectrum transform for generating a substantially flat L-band ASE.

15. The ASE of claim 9 wherein:
said second ASE generated in said gain medium is a C-band optical signal for combining with said substantially flat L-band signal to project an output optical signal having a broadband range over eighty nanometers (nm).

16. The ASE of claim 9 wherein:
said pump splitter is an adjustable pump splitter for adjusting a power ratio of projecting said first and said second pump lights.

17. An amplified spontaneous source (ASE) comprising:
an erbium doped fiber (EDF) for transmitting an amplified spontaneous emission (ASE) signal therein; and
a reflective means for reflecting a reflected ASE having a peak wavelength near a C-band into said EDF for generating a substantially flat L-band optical signal.

18. The ASE of claim 17 further comprising:
a wavelength division-multiplexing (WDM) means for demultiplexing an ASE signal reflected from said reflective means into said EDF.

19. The ASE of claim 17 wherein:
said erbium doped fiber (EDF) having a pre-designated length for effecting a generation of said substantially flat L-band ASE signal.

20. The ASE of claim 17 wherein:
said reflective means comprising a reflective coating coated over an end face of an optical fiber spliced into a wavelength selective means.

21. The ASE of claim 17 further comprising:
a means for pumping a light generating a second C-band ASE signal for combining with said substantially flat L-band signal to project an output optical signal having a broadband range over eighty nanometers (nm).

22. A method for generating a broadband signal comprising:
projecting a first pump light into an gain medium for transmitting and reflecting an ASE signal generated by said pump light in said gain medium for generating a spectrum-transformed ASE signal having a broadband ready-combination spectrum over a range of wavelengths of said broadband signal.

23. The method for claim 22 further comprising:
projecting a second pump light into said gain medium for generating a second ASE signal for combining with said spectrum-transformed ASE signal into said broadband optical signal.

24. An amplified spontaneous source (ASE) comprising:
a single segment of gain medium for outputting a broadband optical signal therefrom.

25. An amplified spontaneous source (ASE) comprising:
a single pump source connecting to a single pump splitter to project two branched pump lights into a single segment of gain medium for outputting a broadband optical signal therefrom.

26. An amplified spontaneous source (ASE) comprising:
a single segment of gain medium for outputting a broadband optical signal therefrom having a broadband range about 80 nanometers and a flat spectrum.
